(19) United States
(12) Patent Application Publication
(10) Pub. No.: US 2014/0092204 A1
(43) Pub. Date: Apr. 3, 2014

(54) DYNAMIC RATE CONTROL ALGORITHM FOR HIGH DEFINITION VIDEO CONFERENCING

(71) Applicant: THE UNIVERSITY OF OTTAWA, Ottawa (CA)

(72) Inventors: Abbas Javadtalab, Gatineau (CA); Shervin Shirmohammadi, Ottawa (CA)

(73) Assignee: THE UNIVERSITY OF OTTAWA, Ottawa (CA)

(21) Appl. No.: 13/632,816

(22) Filed: Oct. 1, 2012

(51) Int. Cl. H04N 7/26; H04N 7/15

(52) U.S. Cl. 348/14.13; 375/240.03; 348/E07.083

(57) ABSTRACT

A computer-implemented method is provided for controlling an encoder that is particularly suited for high definition video conferencing. The method includes: receiving an average allowance of bits for encoding a data frame; receiving a burst allowance for data encoded by the encoder, where the burst allowance specifies a variance above the average allowance for a given time period; determining bits needed to encode an incoming data frame; comparing the bits needed to encode the incoming data frame to the average allowance of bits; computing a bit allowance for the incoming data frame using the bits needed to encode the incoming data frame and the burst allowance when the bits needed to encode the incoming data frame exceeds the average allowance of bits; computing a quantization parameter for the incoming data frame using the bit allowance for the incoming data frame; and providing the quantization parameter to the video encoder.

### FIELD

The present disclosure relates to a dynamic rate control algorithm for high definition video conferencing.

### BACKGROUND

Video conferencing allows two or more locations to communicate using simultaneous two-way video transmissions. Among the different factors that affect user satisfaction during video conferencing, rate adaptation plays an important role. For example, generating video at a bitrate that exceeds network capabilities leads to degradation in video quality. Conversely, generating video at a bitrate below network capabilities is an inefficient use of network resources. Conventional rate control algorithms, however, are unable to address high definition video streaming requirements of video conferencing over best effort networks, such as the Internet. Therefore, it is desirable to develop a dynamic rate control mechanism for use in high definition video conferencing applications.

This section provides background information related to the present disclosure which is not necessarily prior art.

### SUMMARY

A computer-implemented method is provided for controlling an encoder that is particularly suited for a high definition video conferencing application. The method includes: receiving an average allowance of bits for encoding a data frame; receiving a burst allowance for data encoded by the encoder, where the burst allowance specifies a variance above the average allowance for a given time period; determining bits needed to encode an incoming data frame; comparing the bits needed to encode the incoming data frame to the average allowance of bits; computing a bit allowance for the incoming data frame using the bits needed to encode the incoming data frame and the burst allowance when the bits needed to encode the incoming data frame exceeds the average allowance of bits; computing a quantization parameter for the incoming data frame using the bit allowance for the incoming data frame; and providing the quantization parameter to the video encoder.

This section provides a general summary of the disclosure, and is not a comprehensive disclosure of its full scope or all of its features. Further areas of applicability will become apparent from the description provided herein. The description and specific examples in this summary are intended for purposes of illustration only and are not intended to limit the scope of the present disclosure.

### DRAWINGS

FIG. 1 is a block diagram depicting an exemplary video encoding system;

FIG. 2 is flowchart of an improved dynamic rate control algorithm for controlling an encoder that is especially suited for high definition video conferencing applications;

FIG. 3 is a diagram of an exemplary embodiment of the dynamic rate control algorithm;

FIG. 4 is a diagram of an exemplary embodiment of a bitrate modification algorithm;

FIG. 5 is a graph comparing quantization parameters for three select rate control methods;

FIG. 6 is a graph comparing the encoded frame size for three select rate control methods;

FIG. 7 is a graph comparing the encoded frame size (without the I frame) for three select rate control methods;

FIG. 8 is a graph comparing the peak signal-to-noise ratios for three select rate control methods;

FIG. 9 is a graph comparing the structural similarity index for three select rate control methods;

FIG. 10 is a graph comparing the quantization parameter for three select rate control methods when the bitrate has been changed;

FIG. 11 is a graph comparing the frame size values for three select rate control methods when the bit rate has been changed;

FIG. 12 is a graph comparing the peak signal-to-noise ratios for three select rate control methods when the bit rate has been changed;

FIG. 13 is a graph comparing the structural similarity index for three select rate control methods when the bit rate has been changed;

The drawings described herein are for illustrative purposes only of selected embodiments and not all possible implementations, and are not intended to limit the scope of the present disclosure. Corresponding reference numerals indicate corresponding parts throughout the several views of the drawings.

### DETAILED DESCRIPTION

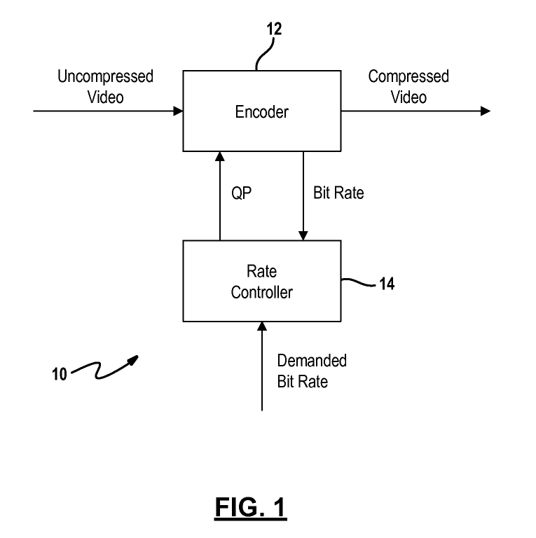

FIG. 1 depicts an exemplary video encoding system 10. The video encoding system 10 is comprised of a video encoder 12 and a rate controller 14. The video encoder 12 is adapted to receive uncompressed data (e.g., video) from a data source and operates to output compressed data. In one example, the video encoder 12 encodes video data in accordance with the H.264/AVC video compression standard. The rate controller 14 implements a rate control algorithm that dynamically adjusts encoder parameters to achieve a target bitrate. Other arrangements for the video encoding system are also contemplated by this disclosure.

Rate distortion is one of the main features addressed in the H.264/AVC standard. Since the standard defines only a bit stream syntax and decoder process, encoder developers have freedom to develop rate control algorithms. Among various H.264 implementations, the x264 open-source implementation has received much attention and is used in many applications such as ffshow, ffmpeg and MEncoder. It is one of the best software codecs on the Internet and its performance is close to or better than some commercial softwares. The main reasons behind the high performance of x264 are its rate control algorithm which is based on the libavcodec implementation, motion estimation, macro block mode decision, quantization, and frame type decision algorithms. There are many parameters in frames and macro blocks which affect the rate-distortion and the final bit rate such as frame types (e.g. I, P or B frame), number of frames, modes to be used for each macro block (e.g. INTRA, INTER, or SKIP, etc.), motion estimation methods (e.g. Full search, tree step search), etc. Practically, rate control can be applied in three different granularity levels: group of pictures level, frame level, and macro-block level. A rate control (RC) algorithm adjusts such parameters to meet a determined video bit rate. While the proposed rate control algorithm described below is discussed in the context of the H.264/AVC standard, it is extendable to other video compression standards as well.

Average bitrate control (ABR) is a known rate control algorithm that tries to assign bitrate to each frame based on a predetermined final bitrate. More specifically, a quantization parameter (QP) for the encoder is calculated based on the bitrates for data frames previously encoded by the video encoder and corresponding quantization parameters used to encode the previously encoded data frames. An exemplary formula for calculating the quantization parameter is as follows:

$${QP}_{n + 1} = \frac{{\sum }_{i = 1}^{n} {B}_{i} {QP}_{i}}{{\sum }_{i = 1}^{n} {W}_{i}} \qquad ( 1 )$$

where QPᵢ is the quantization parameter used to encode data frame i, Bᵢ is the bits consumed for data frame i, and Wᵢ is the desired bitrate for data frame i, respectively. In order to help rate controller to make proper decision for QP value, a proper duration for collecting history should be defined. For example the bitrate used 30 minutes ago is not a good reference to calculate the average bitrate in that a frame of 30 minute before is less similar than a frame from 5 minutes ago. Accordingly, the control algorithm uses from a group of previous frames (referred to as a window) to calculate in current frame QP value. Therefore, formula (1) can be modified as follows:

$$\{ \begin{matrix}{QP}_{n + 1} = \frac{{\sum }_{i = 1}^{n} {B}_{i} {QP}_{i}}{{\sum }_{i = 1}^{n} {W}_{i}} & n \leq k \\ {QP}_{n + 1} = \frac{{\sum }_{i = k}^{n} {B}_{i} {QP}_{i}}{{\sum }_{i = k}^{n} {W}_{i}} & n > k\end{matrix}$$

where k is a fixed integer number which is determined based on the conference environment at the beginning and it is not changed during conference session.

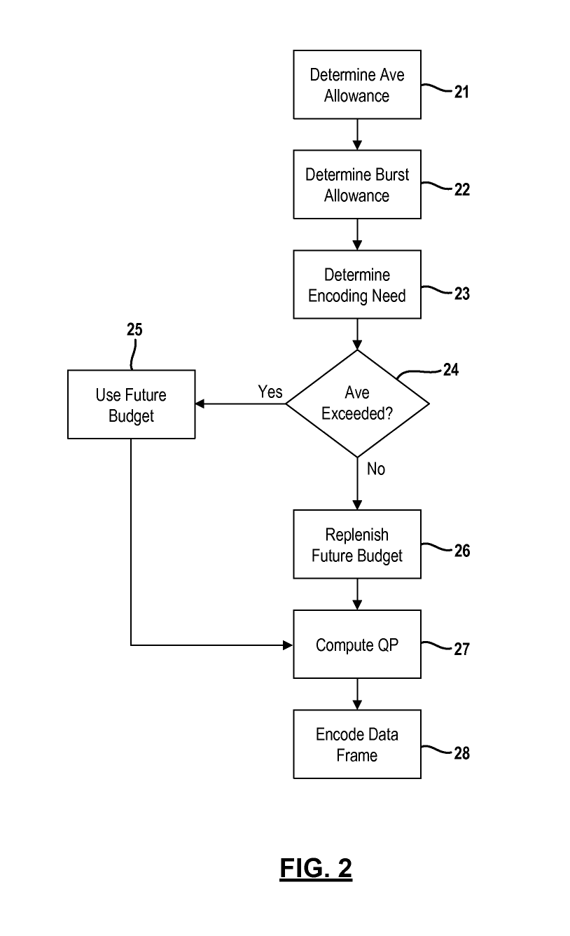

FIG. 2 provides an overview of an improved dynamic rate control algorithm 20 for controlling an encoder that is especially suited for high definition video conferencing applications. The dynamic rate control algorithm 20 tries to achieve the best frame quality in a given bitrate. The dynamic rate control algorithm 20 may be implemented by the rate controller 14.

While the bitrate is fixed, the network delivers data at the specified bitrate with some variations. By definition, the bitrate is the amount of bits that are transferred per unit of time. For instance, the encoder may be configured to encode raw video at 3 Mbit/second. From the specified bit rate, the dynamic rate control algorithm 20 begins by determining an average allowance of bits (i.e., quota) for encoding a data frame as indicated at 21. That is, the average allowance of bits for a given frame is computed by dividing the bit rate by a frame rate, where the bit rate is the average bits per unit of time for the video data as reported by the encoder and the frame rate is received from the source of the data to be encoded by the encoder. By way of example, for a bitrate of 2 Mbit/second and a frame rate of 20 frames per second, the average allowance of bits per data frame is 100 kilobits per frame.

When allocating bits to an incoming data frame, the rate control algorithm 20 uses the concept of a future budget (or bit allowance). The concept of a future budget is very similar to the wage system. An employee may be paid at the beginning of a given month. The employee may pay any fixed expenses for the month and place the surplus money in the bank. The surplus can be used to manage any unexpected expenditures throughout the month. In the case of an unexpected expenditure, the employee can withdraw from the surplus money in the bank to pay for the unexpected expenditure. The proposed rate control algorithm operates in a similar manner.

The rate controller can receive at 22 a burst allowance for data encoded by the encoder, where the burst allowance specifies a variance from the allocated bandwidth for a given period of time and is provided, for example by the network service provider. The burst allowance represents the future budget for the rate controller.

The rate control algorithm 20 can consume up to a percent of the future budget when the bit allowance for an incoming data frame exceeds the average bit allowance, thereby preventing degradation of video quality. Thus, the future budget allows the encoder to tolerate some fluctuations on the output. However, if the consumption of the encoder continues to generate video bit rates over the desired bit rate, the future budget will be depleted such that the video quality will be degraded.

On the other hand, when encoder is generating fewer bits than the desired bit rate, the rate control algorithm 20 can replenish the future budget. The future budget can be increased by the difference between the average bit allowance and the bit allowance for the incoming data frame up to the value of the initial burst allowance.

Upon receipt of an incoming data frame, the rate controller determines at 23 the bits needed to encode the incoming data frame. The number of bits needed to encode the incoming data frame is then compared at 24 to the average bit allowance. When the bits needed to encode the incoming data frame exceeds the average bit allowance, the bit allowance for the incoming data frame is computed at 25 using the future budget. Specifically, the rate controller determines a difference between the bits needed to encode the incoming data frame and the average allowance of bits, subtracts the difference from the future bit allowance (i.e., future budget) to yield an updated future bit allowance, and sets the bit allowance equal to the bits needed to encode the incoming data frame so long as the updated future bit allowance is equal to or greater than zero. In this way, the quality of the video is maintained. Once the future budget is depleted (i.e., the updated future allowance is less than zero), the bit allowance for the incoming frame is set to the average bit allowance and the quality of the video is degraded.

Conversely, when the bits needed to encode the incoming data frame is less than or equal to the average bit allowance, the future budget is replenished at 26. To do so, a difference is computed between the average allowance of bits and the bits needed to encode the incoming data frame. The difference is added to the future bit allowance to yield an updated future bit allowance. The future budget can be increased up to but not to exceed the value of the initial burst allowance. In this case, the bit allowance for the incoming data frame is set to the average bit allowance.

In either case, the quantization parameter for the incoming frame is computed at 27 using the bit allowance allocated to the incoming data frame. In an exemplary embodiment, the quantization parameter is computed using equation (1) although other computational techniques are contemplated by this disclosure. The quantization parameter is then provided at 28 to the video encoder 14 which in turn encodes the incoming data frame in accordance with the provided quantization parameter.

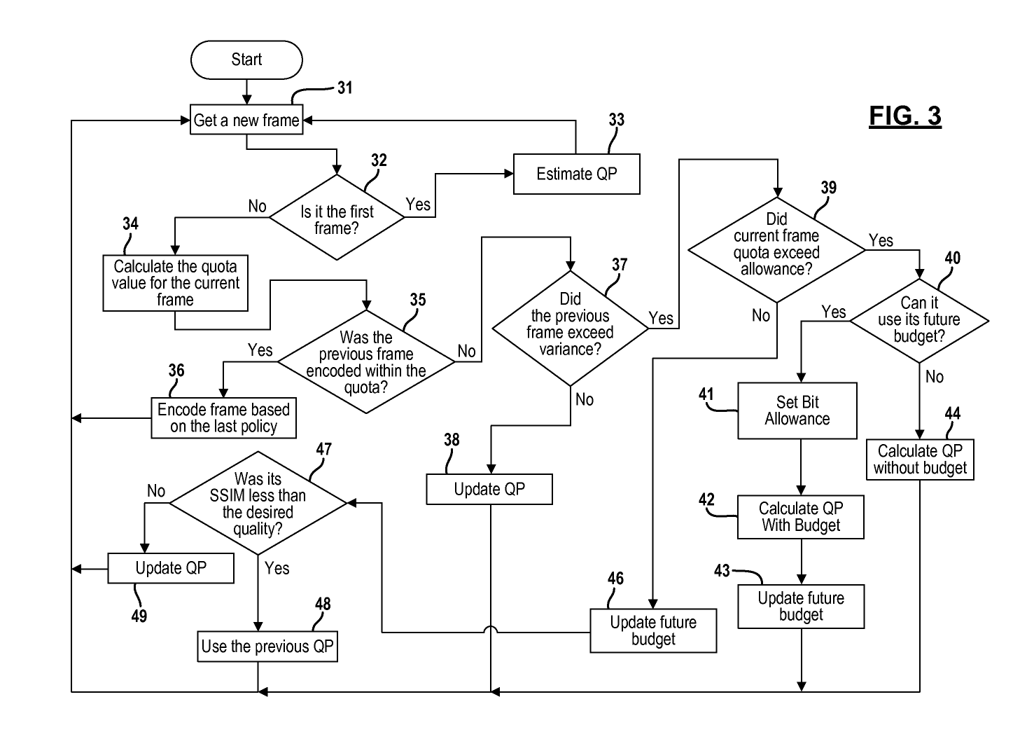

FIG. 3 depicts an exemplary embodiment for the dynamic rate control algorithm 30 which may be implemented by the rate controller 14. The dynamic rate control algorithm 30 processes incoming data frames while the bitrate remains substantially unchanged. In the case of a bandwidth modification, the dynamic rate control algorithm 30 interoperates with the bitrate modification algorithm described below in relation to FIG. 4.

Information pertaining to an incoming data frame is received at 31 by the rate controller. A determination is made at 32 as to whether the incoming data frame is the first frame to be received at a new bitrate. For the first frame, the quantization parameter is estimated as indicated at 33. According to an x264 implementation, the quantization parameter may be estimated as follows:

$$\begin{matrix}\begin{matrix}{last}_{satd} = x {264}_{rc - analyse - slice} ( ) & A function of the x 264\end{matrix} & ( 2 ) \\ {Cplxr}_{{sum}_{n + 1}} = \{ \begin{matrix}0.1 \times {700000}^{qcompress} \times {Macroblock}_{number}^{qcompress} & if n = 0 \\ {Cplxr}_{{sum}_{n}} + \frac{{Generated}_{bits} \times qp 2 scale ( {qpa}_{rc} )}{{blured}_{complesity}^{1 - qcompress )}} & otherwise\end{matrix} & ( 3 ) \\ {blured}_{complexity} = \frac{Cplxr - {sum}_{short term}}{Cplxr - {count}_{short term}} & ( 4 ) \\ Cplxr - {count}_{short {term}_{n + 1} = \frac{Cplxr - {count}_{short {term}_{n}}}{2} + 1} & ( 5 ) \\ Cplxr - {sum}_{short {term}_{n + 1}} = \frac{Cplsr - {sum}_{short {term}_{n}}}{2} + {last}_{satd} \times fps & ( 6 ) \\ {q}_{1} = \frac{{complex}_{sum} \times {blured}_{complexity}^{1 - qcompress}}{wanted\_bit \_windows} & ( 5 ) \\ \begin{matrix}qcompress = 0.6 & Default value\end{matrix} & ( 6 ) \\ qp 2 scale ( qp ) = 0.85 * {2}^{\frac{qp - 12}{6}} & ( 7 )\end{matrix}$$

where Generated_{bits} and wanted_bit_window represent the encoded frame size and the desired frame size, respectively. The estimated quantization parameter is in turn passed by the rate controller 12 to the video encoder 14 and used to encode the first data frame.

For the frames following the first frame, a determination is made at 34 as to the bits needed to encode the current frame. The actual number of bits used to encode the previous frame is then compared at 35 to the average allowance of bits for encoding a data frame, where the actual number of bits used to encode the previous data frame is provided by the encoder to the rate controller. As noted above, the average allowance of bits may be computed by dividing the bit rate by the frame rate. When the actual bits needed to encode the previous frame is substantially equal to the average bit allowance, the current frame can be encoded without modifying the encoder parameters (i.e., using QP from previously encoded data frame) as indicated at 36.

When the actual bits needed to encode the previous data frame differs from the average bit allowance, a second determination is made at 37 to determine whether the actual bits needed to encode the data frame fall within a variance (e.g., ±10% of average bit allowance). If the bits needed fall within the variance, the quantization parameter is updated at 38 and the updated quantization parameter is used to encode the current frame. In the exemplary embodiment, the quantization parameter is updated using equation (1) above.

When the actual bits needed to encode the previous data frame falls outside of the variance, a determination is made at 39 as to whether the bits needed to encode the incoming data frame exceeds the average bit allowance or are below the average bit allowance. If the bits needed exceed the average bit allowance, then a determination is made at 40 as to whether the future bit allowance can be used to encode the incoming data frame. To do so, the rate controller determines a difference between the bits needed to encode the incoming data frame and the average allowance of bits and subtracts the difference from the future bit allowance to yield an updated future bit allowance. If the updated future bit allowance is equal to or greater than zero, then the quantization parameter can be calculated using the future bit allowance. Specifically, the bit allowance for the current frame is set at 41 to the number of bits needed to encode the incoming data frame and the quantization parameter is calculated at 42 using the set bit allowance. The quantization parameter can be calculated using equation (1) above. Lastly, future bit allowance is updated at 43 by subtracting the difference at 42 from the future bit allowance to yield an updated future bit allowance.

The future budget has been depleted if the update future bit allowance is less than zero. In this case, the quantization parameter is calculated at 44 without the benefit of the future budget. That is, the bit allowance for the incoming frame is set to the average bit allowance and the quantization parameter is calculated using equation (1) above. In such as case, because the number of bits needed to encode the current data frame is more than the average bit allowance, the video quality will be degraded.

If the bits needed are less than the average bit allowance, then the future budget can be replenished at 46. To do so, the rate controller determines a difference between the average allowance of bits and the bits needed to encode the incoming data frame. The future bit allowance can be replenished by adding the difference to the future bit allowance to yield an updated future bit allowance. The future budget can be increased up to but not to exceed the value of the initial burst allowance.

In the exemplary embodiment, the quantization parameter for the incoming data frame may depend upon the structural similarity (SSIM) index for the previous data frame. The SSIM is compared at 47 to a desired quality level. If the SSIM meets the desired quality level, the quantization parameter for the previous data frame is used at 48 to encode the current data frame. If the SSIM does not meet the desired quality level, the quantization parameter for the current data frame is calculated at 49 using equation (1) above. In this case, the bit allowance for the current frame is set to the average bit allowance. SSIM is a known method for measuring the similarity between two images. Other types of quality measures, such as PSNR, VQM, MPQM, NQM and other indicators of video quality also fall within the scope of this disclosure.

An example scenario is set forth below to illustrate the concept. In this example scenario, assume the average bit allowance is 100 kilobits per frame and the burst allowance is 200 kilobits per frame. When the bits needed to encode a first incoming data frame is 150 kilobits, the future bit allowance is adjusted from 200 to 150 kilobits per frame. When the bits needed to encode a second incoming data frame is 200 kilobits, the future bit allowance is adjusted from 150 to 50 kilobits per frame. If the bits needed to encode a third incoming data frame is 175 kilobits, the future bit allowance is adjusted from 50 to 0. Conversely, if the bits needed to encode the third incoming data frame is 50, the future bit allowance is adjusted upward from 50 to 100 kilobots per frame. Note that the future bit allowance can not be adjusted to a value higher than the initial burst allowance (i.e., 200 kilobits per frame).

FIG. 4 depicts an exemplary embodiment of a bitrate modification algorithm 50 that interoperates with the dynamic rate control algorithm 30 described above. During operation, the rate controller 14 may receive an indication of a bandwidth modification at 51 from the network service provider, network monitor or any other indicator of change in available network bandwidth. Upon receipt of a bandwidth modification, the rate controller 14 will rapidly adjust the current bit rate to a new bitrate.

While adjusting to the new bitrate, the rate controller 14 operates in a “transient” state as indicated at 52. Previous history for calculating the quantization parameter in accordance with equation (1) is cleared (i.e., summations set to zero) as indicated at 53. For the first data frame at the new bitrate, the quantization parameter for the video encoder 14 is initially estimated at 54. In an exemplary embodiment, the quantization parameter may be estimated using equations (2)-(7) set forth above. The first data frame is then encoded at 55 with the estimated quantization parameter.

Next, a determination is made at 56 as to whether the encoder output was generated at a bitrate close to the desired new bitrate. If the generated bitrate has not yet reached the desired new bitrate, the quantization parameter for the next incoming data frame is calculated at 57 using equation (1) above. The quantization parameter is used by the video encoder at 55 to encode the next incoming data frame. The process is repeated until generated bitrate reaches the desired new bitrate. Because this equation does not have any previous history, steps between the quantization parameters are large, thereby converging the generated bitrate quickly to the desired new bit rate.

Once the generated bitrate reaches the desired new bitrate, the rate controller 14 operates is a “steady” state as indicated at 58. That is, the rate controller 14 beings processing incoming data frames using, for example the dynamic rate control algorithm 30 described above in relation to FIG. 3. Before doing so, the history for calculating the quantization parameter during the transient state is cleared (i.e., summation set to zero) at 59. In one exemplary embodiment, the quantization parameter last used by the video encoder during the transient state may be used when computing the quantization parameter in the steady state for next data frame. In another exemplary embodiment, the initial value for the quantization parameter in the steady state can be approximated by

$$qp = \frac{{generated}_{bits} \times qp 2 qcale ( {qp}_{rc} )}{wanted\_bit \_windows} \qquad ( 8 )$$

where this equation is a simple approximation of equation (5). Some of the parameters, such as blured_{complexity}, Cplxrₛᵤₘ, and wanted_bit_windows, should be modified according to the new bitrate.

The proposed dynamic rate control algorithm described above was compared with other rate control mechanisms in terms of bandwidth, frame size, PSNR values for Y, and SSIM values for different types of the high definition video conferencing (HDVC) environment from low activity video conferencing to high activity even noisy background. That is, rate in HDVC in two main situations: fixed bit rate where the bit rate doesn't change significantly around session, and variable bit rate in which the bit rate if changed from 2 Mbps to 1.5 Mbps. In the first situation, the desired bit rate for all test cases was targeted at 2 Mbps; i.e., the current available bandwidth is assumed to be around 2 Mbps and then measured how different rate control algorithms reacted in that situation. The videos which are used in this simulation were taken from an actual HDVC session. For the simulation, the low activity video is the video that a person is sitting in front of the camera in which the background has almost no modifications. For example, the person talks, moves his head, raises his hands. Moreover, there is a whiteboard behind the person with some texts written on it. The quality of the text is one of the areas which is evaluated in the subjective tests.

Performance of three select rate control methods are evaluated and described in terms of matched bit rate and video quality. The three select rate control methods include: an average bitrate method (ABR); constant rate factor method (CRF); and the proposed dynamic rate control algorithm 20.

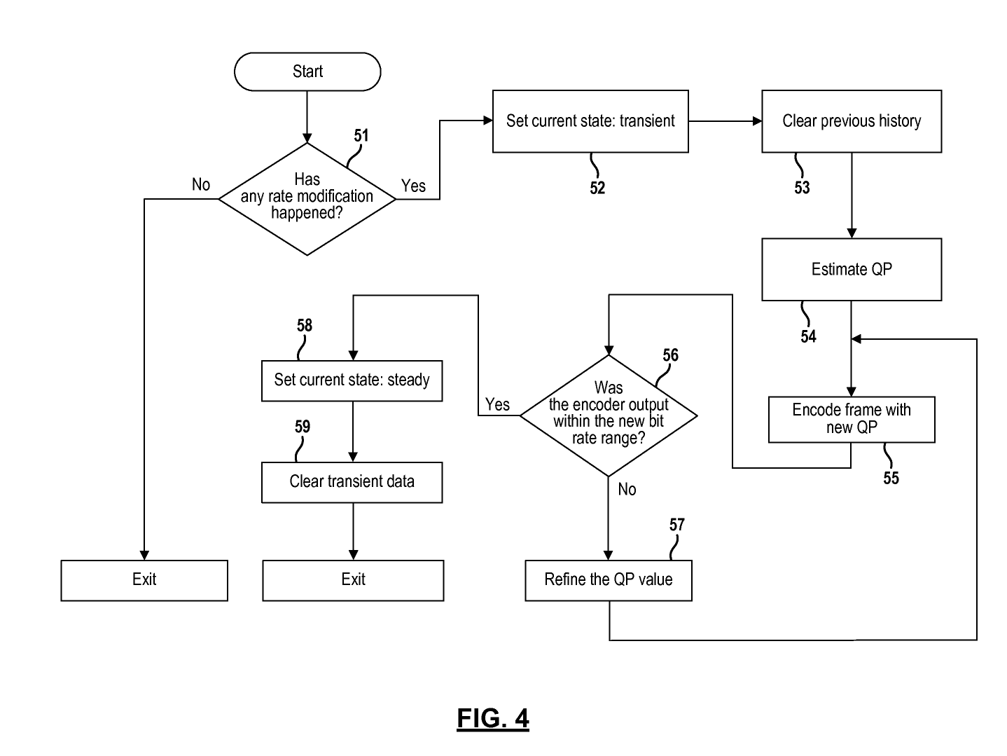

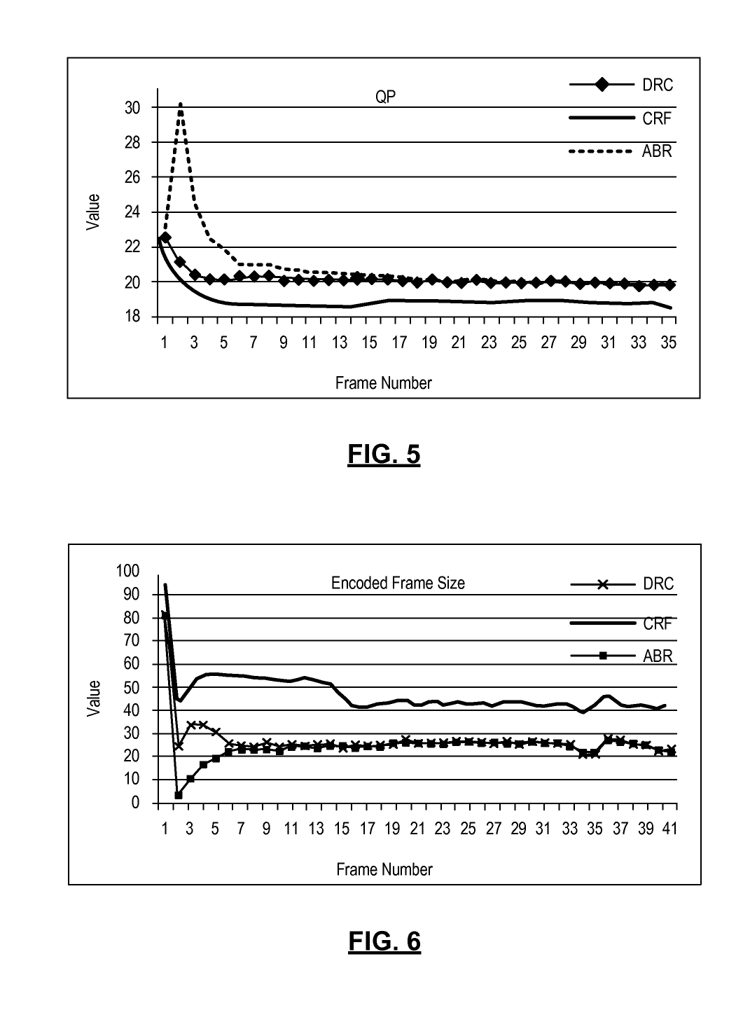

FIG. 5 illustrates the QP value of each of three select methods. For simplicity, only the first 40 frames are shown. The value of QP determines the quality of the video. The larger the QP value, the more video quality degradation can be perceived. As can be seen from this figure, the proposed dynamic rate control algorithm 20 offers a consistent QP value throughout the simulation and it is very similar to the CRF in the given bit rate while the CRF doesn't care about the video bit rate (as will be shown in FIG. 6). Furthermore, ABR has some fluctuations from frame 2 to frame 5 that leads to fluctuation on the quality of those frames. In terms of QP, the proposed dynamic rate control algorithm 20 offers consistent QP value during the video session.

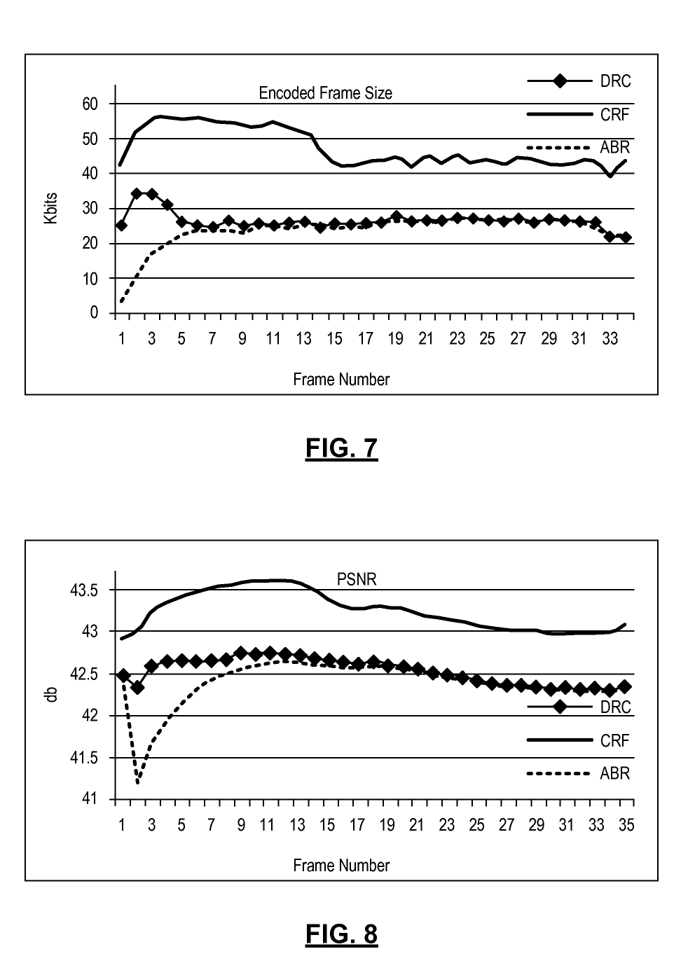

In order to compare the proposed dynamic rate control algorithm 20 against the other rate control methods, it is required to generate a similar bit rate between all of them. Therefore, the CRF method was set up to 21 for a 2.7 Mbps bit rate without using VBV. This is the best possible value to generate the closest bit rate to 2 Mbps. The ABR method and the proposed dynamic rate control algorithm 20 generated bit rates were 2 Mbps. The first frame is encoded as an I frame and the next frames are encoded as P frames. That is why the first frame in FIG. 6 has a bigger size. However, the size of the next frames varies according to the policy. In order to get a better view of the rate control performance, FIG. 7 displays the same result as FIG. 6 but starting from frame 1 instead of frame 0.

FIGS. 6 and 7 show the frame size which directly relates to the bit rate. Each frame is generated in a portion of time, and a collection of frames generated in a time unit, second, defines the bit rate. According to the figures, the proposed dynamic rate control algorithm 20 has a similar pattern to CRF method. This means that the proposed dynamic rate control algorithm 20 decreases the amount of the bit rate while there is little movement in the video and vice versa when there is more activity in the video, similar to CRF method. ABR method generates a small bit rate at first, because it does not have previous knowledge about each frame, and then increases the bit rate to reach the average rate. This causes the video quality of the ABR method to be low at the beginning (as shown in FIGS. 8 and 9). On the other hand, the CRF method generated larger frame size as it cannot reach the required bit rate. This means that many packets of the CRF method will be dropped due to network bandwidth restriction. Hence, the proposed dynamic rate control algorithm 20 can generate video according to both the network capacity and the desired high quality of the video.

As can be seen in FIG. 8, the ABR method has the lowest quality at first although the quality is improved as time passes. The quality of the proposed dynamic rate control algorithm 20 is not comparable with CRF method since their bit rates are not the same. But the proposed dynamic rate control algorithm 20 quality is more than ABR method and offers consistent quality throughout the video conversation.

Similar to PSNR, SSIM is another video quality indicator. Similar to FIG. 8, in FIG. 9 it is shown that the quality generated by ABR method is the worst at the beginning, and CRF method has the highest quality as expected but the quality of the CRF method is not valid since it generates more bit rate than network capacity. So, considering to the network capacity, the proposed dynamic rate control algorithm 20 offers the best possible quality in the given bit rate. The proposed dynamic rate control algorithm 20 behaves similar to the CRF method. This is very interesting when considering that the CRF's bit rate cannot be controlled directly (only the QP value can be controlled directly) while the proposed dynamic rate control algorithm 20 can generate video at the desired bit rate.

In the above tests, the proposed dynamic rate control algorithm 20 is compared with other rate control methods when the network capacity doesn't change. We can see that even in these situations, the proposed dynamic rate control algorithm 20 has valuable advantages over the other rate control algorithms. However, the worthiness of the proposed dynamic rate control algorithm 20 will be even more obvious when the network bandwidth changes. The faster a rate control algorithm adjusts to a new network bandwidth, the smaller the negative effects of the network will be in the video conversation. This premise was tested and the results are discussed next.

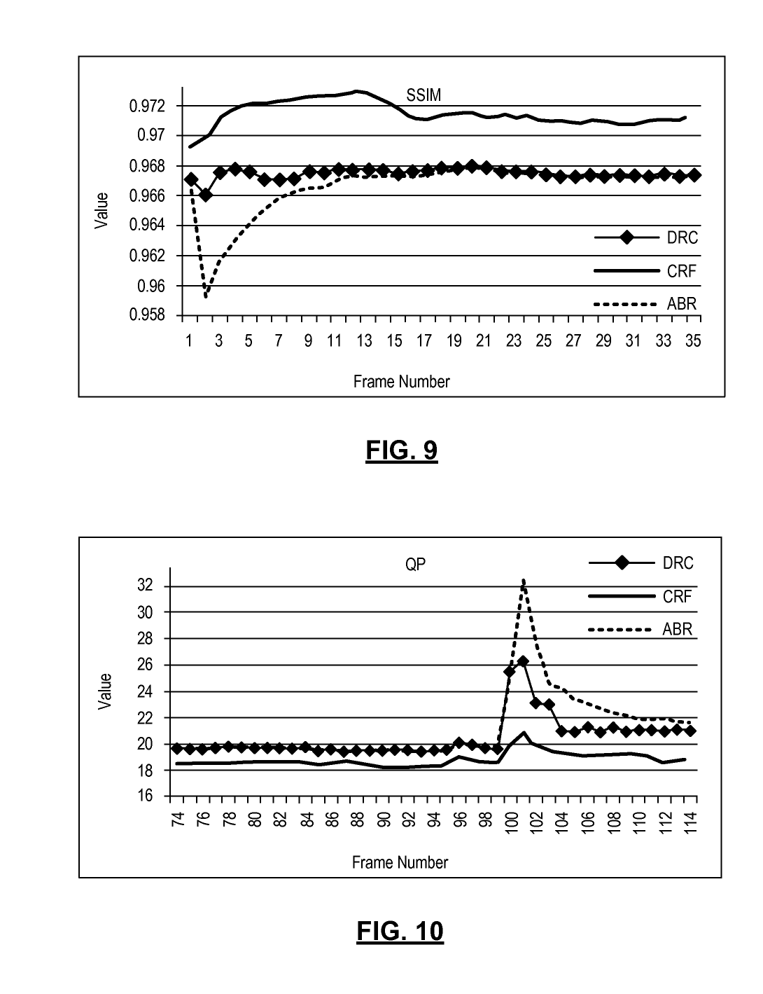

In one simulation, the video bit rate was changed from 2 Mbps to 1.5 Mbps. With reference to FIG. 10, the rate modification occurred at frame number 101. The ABR method exhibited a huge change in QP which means a huge adverse impact on video quality. In addition, it took about 13 frames to reach new bit rate. The CRF method has only a few changes because it could not find the suitable QP values for new bit rate, and so it cannot match the new network bandwidth and so many of its frames will be lost and the video quality will degrade significantly. In contrast, the proposed dynamic rate control algorithm 20 has the fastest adjustment. It not only can reach the new bit rate but does so at frame 105 (i.e., in 4 frames).

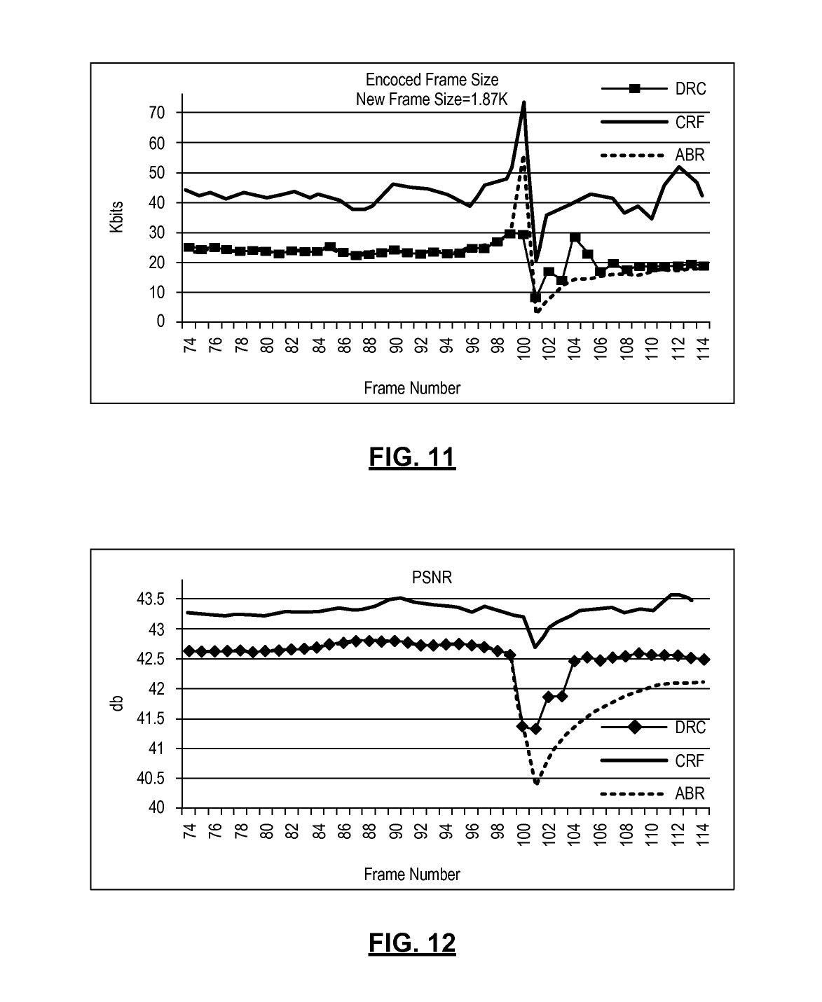

Frame size values are evaluated when the bitrate has been changed as shown in FIG. 11. The ABR method generates the huge frame size at the frame 101 at which the network modification has happened because it must close the encoder and reopen it after reconfiguration. The CRF method has also the same behavior but it cannot reach the new bit rate at all. The proposed dynamic rate control algorithm 20, on the other hand, reaches to the new bit rate with the least possible overhead (0 in this example). This is a significant advantage of the proposed dynamic rate control algorithm 20.

With regard to PSNR, the ABR method generate the huge negative impact of the quality (especially in frame 101) and then increase the video quality as shown in FIG. 12. CRF method has also some fluctuations around frame 101. However, the result is not comparable with the other rate controllers as it has failed to adjust the bit rate. Again the proposed dynamic rate control algorithm 20 is able to recover quality and reach the final bit rate much faster than the ABR method.

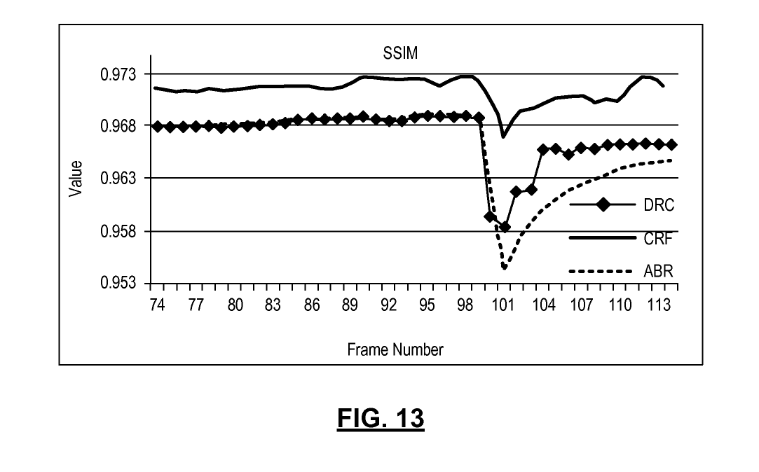

Similar behavior was observed in relation to SSIM as shown in FIG. 13. The ABR quality merges to the new bit rate after a long time while the proposed rate control algorithm 20 reaches the new bit rate in only 4 frames. The CRF method has failed to reach the new bit rate.

The techniques described herein may be implemented by one or more computer programs executed by one or more processors. The computer programs include processor-executable instructions that are stored on a non-transitory tangible computer readable medium. The computer programs may also include stored data. Non-limiting examples of the non-transitory tangible computer readable medium are nonvolatile memory, magnetic storage, and optical storage.

Some portions of the above description present the techniques described herein in terms of algorithms and symbolic representations of operations on information. These algorithmic descriptions and representations are the means used by those skilled in the data processing arts to most effectively convey the substance of their work to others skilled in the art. These operations, while described functionally or logically, are understood to be implemented by computer programs. Furthermore, it has also proven convenient at times to refer to these arrangements of operations as modules or by functional names, without loss of generality.

Unless specifically stated otherwise as apparent from the above discussion, it is appreciated that throughout the description, discussions utilizing terms such as “processing” or “computing” or “calculating” or “determining” or “displaying” or the like, refer to the action and processes of a computer system, or similar electronic computing device, that manipulates and transforms data represented as physical (electronic) quantities within the computer system memories or registers or other such information storage, transmission or display devices.

Certain aspects of the described techniques include process steps and instructions described herein in the form of an algorithm. It should be noted that the described process steps and instructions could be embodied in software, firmware or hardware, and when embodied in software, could be downloaded to reside on and be operated from different platforms used by real time network operating systems.

The present disclosure also relates to an apparatus for performing the operations herein. This apparatus may be specially constructed for the required purposes, or it may comprise a general-purpose computer selectively activated or reconfigured by a computer program stored on a computer readable medium that can be accessed by the computer. Such a computer program may be stored in a tangible computer readable storage medium, such as, but is not limited to, any type of disk including floppy disks, optical disks, CD-ROMs, magnetic-optical disks, read-only memories (ROMs), random access memories (RAMs), EPROMs, EEPROMs, magnetic or optical cards, application specific integrated circuits (ASICs), or any type of media suitable for storing electronic instructions, and each coupled to a computer system bus. Furthermore, the computers referred to in the specification may include a single processor or may be architectures employing multiple processor designs for increased computing capability.

The algorithms and operations presented herein are not inherently related to any particular computer or other apparatus. Various general-purpose systems may also be used with programs in accordance with the teachings herein, or it may prove convenient to construct more specialized apparatuses to perform the required method steps. The required structure for a variety of these systems will be apparent to those of skill in the art, along with equivalent variations. In addition, the present disclosure is not described with reference to any particular programming language. It is appreciated that a variety of programming languages may be used to implement the teachings of the present disclosure as described herein.

The present disclosure is well suited to a wide variety of computer network systems over numerous topologies. Within this field, the configuration and management of large networks comprise storage devices and computers that are communicatively coupled to dissimilar computers and storage devices over a network, such as the Internet.

The foregoing description of the embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

What is claimed is:

1. A computer-implemented method for controlling an encoder in a high definition video conferencing application, comprising:
receiving, by a rate controller, an average allowance of bits for encoding a data frame;
receiving, by the rate controller, a burst allowance for data encoded by the encoder, where the burst allowance specifies a variance above the average allowance for a given time period;
determining, by the rate controller, bits needed to encode an incoming data frame;
comparing, by the rate controller, the bits needed to encode the incoming data frame to the average allowance of bits;
computing, by the bit rate controller, a bit allowance for the incoming data frame using the bits needed to encode the incoming data frame and the burst allowance when the bits needed to encode the incoming data frame exceeds the average allowance of bits;
computing, by the rate controller, a quantization parameter for the incoming data frame using the bit allowance for the incoming data frame; and
providing, by the rate controller, the quantization parameter to the video encoder.

2. The computer-implemented method of claim 1 wherein computing a bit allowance further comprises:
setting a future bit allowance equal to the burst allowance;
computing a difference between the bits needed to encode the incoming data frame and the average allowance of bits when the bits needed to encode the incoming data frame exceeds the average allowance of bits;
subtracting the difference from the future bit allowance to yield an updated future bit allowance; and
setting the bit allowance equal to the bits needed to encode the incoming data frame when the updated future bit allowance exceeds zero.

3. The computer-implemented method of claim 2 wherein computing a bit allowance further comprises
setting the bit allowance equal to the average allowance of bits when the updated future bit allowance is less than zero.

4. The computer-implemented method of claim 2 wherein computing a bit allowance further comprises
computing a difference between the average allowance of bits and the bits needed to encode the incoming data frame when the bits needed to encode the incoming data frame is less than the average allowance of bits; and
adding the difference to the future bit allowance to yield an updated future bit allowance.

5. The computer-implemented method of claim 1 wherein computing a quantization parameter for the incoming data frame is based on a summation of bit rates for data frames previously encoded by the video encoder and a summation of corresponding quantization parameters used to encode the previously encoded data frames.

6. The computer-implemented method of claim 1 further comprises
receiving, by the rate controller, a first data frame from a data source prior to receiving the incoming data frame;
estimating, by the rate controller, a quantization parameter for the first data frame; and
providing, by the rate controller, the estimated quantization parameter to the video encoder.

7. The computer-implemented method of claim 6 further comprises
receiving a bit rate from the video encoder, where the bit rate was generated from encoding the first data frame; and
determining the average allowance of bits by dividing the bit rate by a frame rate received from a source of the data frame.

8. The computer-implemented method of claim 1 further comprises
receiving, by the rate controller, a bandwidth modification that specifies a new target bitrate;
estimating a quantization parameter for a first data frame encoded at the new target bitrate; and
encoding the first data frame using the estimated quantization parameter.

9. The computer-implemented method of claim 8 further comprises:
(a) receiving a bit rate at which the first data frame was generated at;
(b) comparing the generated bit rate with the new target bitrate;
c) computing a quantization parameter for a next data frame when the generated bit rate differs substantially from the new target bitrate, the computation of the quantization parameter is based on a summation of bit rates for data frames previously encoded by the video encoder and a summation of corresponding quantization parameters used to encode the previously encoded data frames; and
(d) encoding the next data frame using the computed quantization parameter.

10. The computer-implemented method of claim 9 further comprises receiving a bit rate at which a previous data frame was generated at and repeating steps (b)-(d) until the generated bit rate substantially equals the new bitrate.

11. A computer-implemented method for controlling an encoder in a high definition video conferencing application, comprising:
receiving, by the rate controller, an average allowance of bits for encoding a data frame;
receiving, by the rate controller, a burst allowance for data encoded by the encoder, where the burst allowance specifies a variance above the average allowance for a given time period;
setting a future bit allowance equal to the burst allowance;
determining, by the rate controller, bits needed to encode an incoming data frame;
comparing, by the rate controller, the bits needed to encode the incoming data frame to the average allowance of bits;
computing a difference between the bits needed to encode the incoming data frame and the average allowance of bits;
subtracting the difference from the future bit allowance to yield an updated future bit allowance when the bits needed to encode the incoming data frame exceeds the average allowance of bits;
setting the bit allowance equal to the bits needed to encode the incoming data frame when the bits needed to encode the incoming data frame exceeds the average allowance of bits and the updated future bit allowance exceeds zero;
adding the difference to the future bit allowance to yield an updated future bit allowance when the bits needed to encode the incoming data frame is less than the average allowance of bits;
setting the bit allowance equal to the average allowance of bits when the bits needed to encode the incoming data frame is less than the average allowance of bits or the updated future bit allowance is less than zero;
computing, by the rate controller, a quantization parameter for the incoming data frame using the bit allowance for the incoming data frame; and
providing, by the rate controller, the quantization parameter to the video encoder.

12. The computer-implemented method of claim 11 further comprises encoding, the encoder, the incoming data frame using the quantization parameter.

13. The computer-implemented method of claim 11 wherein computing a quantization parameter
$${QP}_{n + 1} = \frac{{\sum }_{i = 1}^{n} {B}_{i} {QP}_{i}}{{\sum }_{i = 1}^{n} {W}_{i}}$$
where QPᵢ is the quantization parameter used to encode the incoming data frame i, Bᵢ is the bits consumed for data frame i, and Wᵢ is the desired bitrate for data frame i.

14. The computer-implemented method of claim 11 further comprises
receiving, by the rate controller, a first data frame from a data source prior to receiving the incoming data frame;
estimating, by the rate controller, a quantization parameter for the first data frame; and
providing, by the rate controller, the estimated quantization parameter to the video encoder.

15. The computer-implemented method of claim 14 further comprises
receiving a bit rate from the video encoder, where the bit rate was generated from encoding the first data frame; and
determining the average allowance of bits by dividing the bit rate by a frame rate received from a source of the data frame.

16. A computer-implemented method for controlling an encoder in a high definition video conferencing application, comprising:
receiving, by a rate controller, an indication of a bandwidth modification that specifies a new target bitrate;
estimating, by the rate controller, a quantization parameter for a first data frame encoded at the new target bitrate;
encoding, by an encoder, the first data frame using the estimated quantization parameter.
receiving, by the rate controller, a bit rate at which the first data frame was generated at;
comparing, by the rate controller, the generated bit rate with the new target bitrate;
computing, by the rate controller, a quantization parameter for a next data frame when the generated bit rate differs substantially from the new target bitrate, the computation of the quantization parameter is based on a summation of bit rates for data frames previously encoded by the encoder and a summation of corresponding quantization parameters used to encode the previously encoded data frames; and
encoding, by the encoder, the next data frame using the computed quantization parameter.

17. A video encoding system, comprising:
a rate controller operable to determine bits needed to encode an incoming data frame and to compare the bits needed to encode the incoming data frame to an average allowance of bits; the rate controller further operable to compute a bit allowance for the incoming data frame using the bits needed to encode the incoming data frame and a burst allowance when the bits needed to encode the incoming data frame exceeds the average allowance of bits and to further compute a quantization parameter for the incoming data frame using the bit allowance for the incoming data frame, where the burst allowance specifies a variance above the average allowance for a given time period; and
an encoder configured to receive the incoming data frame and operable to encode the incoming data frame using the quantization parameter.
